(19) United States
(12) Patent Application Publication
(10) Pub. No.: US 2007/0251765 A1
(43) Pub. Date: Nov. 1, 2007

(54) Device for the Detection of Foreign Objects, and Particularly Fingers, Between the Doors and the Contiguous Walls of an Elevator Car With Glass Doors, and Elevator Equipped Therewith

(76) Inventor: Gary Copsey, Gien (FR)

Correspondence Address: OTIS ELEVATOR COMPANY;INTELLECTUAL PROPERTY DEPARTMENT, 10 FARM SPRINGS, FARMINGTON, CT, 06032, US

(21) Appl. No.: 11/660,186

(22) PCT Filed: Sep. 3, 2004
(86) PCT No.: PCT/IB04/02895

§ 371 Date: Feb. 13, 2007

(51) Int. Cl. B66B 13/14

(52) U.S. Cl. 187/314

(57) ABSTRACT

The invention relates to a device for the detection of foreign objects, and particularly fingers (13), between the doors and the contiguous walls of landing and car openings in an elevator with glass car (3) and landing (5) doors, characterized in that it comprises a means (17) to deliver a curtain-shaped light beam, located near an opening frame edge (11) of the car, which beam extends transversally across said car (3) and landing (5) glass doors from the vertical car opening frame edge (11) to the opposite vertical landing frame edge (15) and across all of their respective lengths or heights, and a means (23) to receive the emitted light beam and adapted to detect any obstacle to said transverse light 'beam and to order the simultaneous halt and reversal, as required, of car (3) and landing (5) door displacement at said elevator landing level, wherein the detection device is actuated by a car and landing door opening command at a determined storey in the building.

This invention relates to a device for the detection of foreign objects, and particularly fingers, between the doors and the contiguous walls of an elevator car with glass doors, and to an elevator equipped therewith.

Elevators with glass car and landing doors may entail a risk of fingers getting trapped in the space between the doors and the contiguous frame walls, particularly for children who are attracted by the impression of void created by the transparency of the doors.

However, a known device for the detection of foreign objects or obstacle is provided at the level of the landing doors, with a light beam covering each of the elevator landing doors laterally and in its plane. This device requires implanting a detection device at the level of each elevator landing door, and it is therefore relatively cumbersome to implement and expensive.

This invention aims at suppressing the disadvantages of existing devices and proposes a device for the detection of foreign objects, and particularly fingers, between the doors and the contiguous walls of landing and car openings in an elevator with glass car and landing doors, characterized in that it comprises a means to deliver a curtain-shaped light beam, located near an opening frame edge of the car, which beam extends transversally across said car and landing glass doors from the vertical car opening frame edge to the opposite vertical landing frame edge and across all of their respective lengths or heights, and a means to receive the emitted light beam and adapted to detect any obstacle to said transverse light beam and to order the simultaneous halt and reversal, as required, of car and landing door displacement at said elevator landing level, wherein the detection device is actuated by a car and landing door opening command at a determined storey in the building.

Said light beam emitted from a vertical car frame opening edge is advantageously reflected on the opposite vertical landing frame opening edge, e.g. by a strip-shaped vertical reflective surface arranged along the length of that vertical edge, and is received by said beam receiving means arranged on the car side.

Said reflective surface can have a regular concave cross-section along its height, in order to converge the reflected beam onto the beam receiving means.

Such a reflective surface can be formed by the polished surface of the landing frame edge, which can be made e.g. of stainless steel, reflective plastic, reflective glass etc.

Said beam receiving means can be a vertical light-receptive strip arranged near the vertical car opening frame edge and made e.g. of photoelectric cells arranged regularly along its length, wherein the electrical signals delivered thereby are transmitted to a door control circuit.

This arrangement as per the invention has the result that the detection device as per the invention is fitted only on the elevator car, whatever the type of door opening system—whether lateral, central, multi-section, or other. In addition, this equipment is compact and inexpensive.

This invention also relates to an elevator equipped with the detection device defined above.

The invention is illustrated below on the basis of an exemplary embodiment with reference to the appended drawings, in which:

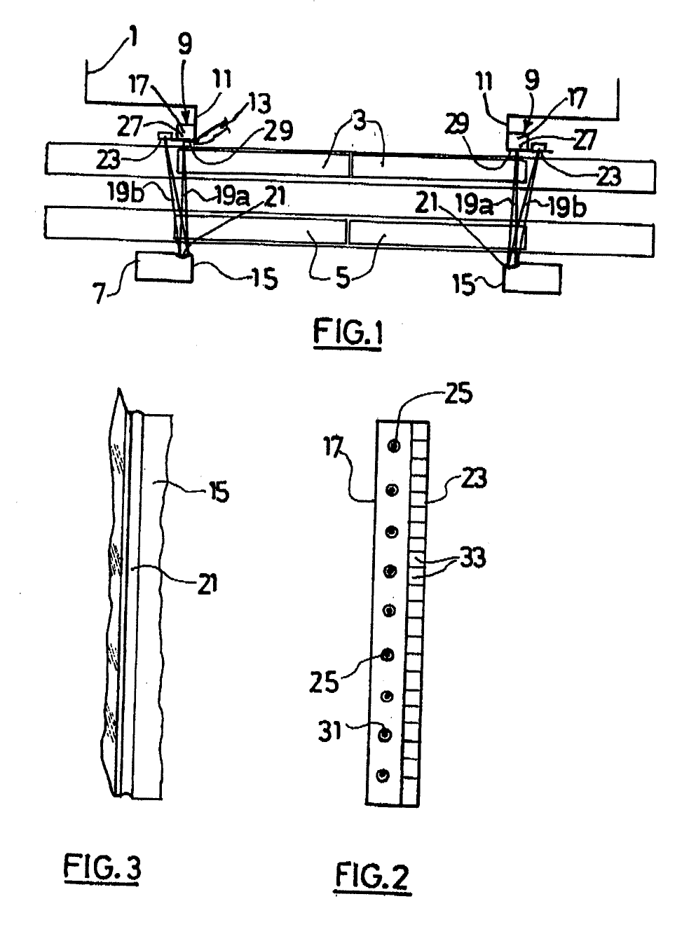

FIG. 1 is a schematic top view of the detection device as per the invention, operating on the car and landing glass doors of an elevator;

FIG. 2 shows the light emission and reception means on a vertical car opening frame edge, and

FIG. 3 shows the surface reflecting the emitted light beam on the landing opening frame edge.

Referring now to FIG. 1, the obstacle detection device as per the invention, as represented in a top view, is fitted on an elevator car 1 equipped with two transparent glass doors 3 opening in the middle. Similarly, the corresponding doors 5 of the elevator landing 7 at each storey of the building are made of glass and transparent, wherein these landing doors 5 open and close in the middle synchronously with and parallel to the car doors 3.

Two detection devices 9 are used. These devices are identical. They are mounted in opposition, each on a vertical front edge 11 of the car opening frame in a symmetrical arrangement relative to a middle transverse plane of the car.

These detection devices 9 are designed to detect the presence of foreign bodies, and particularly fingers 13, between the opening frame edges of the car 11 and of the landing 15 and the car doors 3 and landing doors 5, respectively. These devices are actuated only by a car door opening command, for which there is a risk that objects or fingers 13 can be pulled inwards and trapped with a risk of injury. They are therefore inactive with the door closure command, when no object can be trapped.

Each detection device 9 comprises an emitting means 17 for a light beam 19a, a reflective means 21 to reflect the emitted beam and a receiving means 23 to receive the reflected beam 19b. The beam emitting 17 and receiving 23 means are arranged adjacent to each other on the vertical car opening frame edge 11.

The emitting means 17 (FIG. 2) is made of a series of unitary light sources 25 spaced regularly on a vertical line along the vertical car opening frame edge 11. These light sources 25 are each mounted in a box 27 attached on the back of the front wing 29 of the car frame profile edge 11. Each of these light sources 25 sends a light beam through a hole 31 drilled in said front profile wing 29. This beam is flat and perpendicular to said wing. The individual light beams emitted by the light sources 25 overlap and form the curtain-shaped light beam 19a, which diverges slightly outwards and is transversal to said car 3 and landing 5 glass doors. This beam 19a crosses the car and landing glass doors, extending from the vertical car opening frame edge 11 to the opposite vertical landing frame edge 15 and over all of their respective heights. It thus scans the entire space between the doors and the contiguous walls of the car and landing frame edge from top to bottom.

The emitted beam 19a, after crossing the glass doors, is reflected at 19b on the opening frame edge 15 of the landing, opposite the car frame edge. It is reflected by said reflective means 21, which is made (FIG. 3) of a vertical reflective strip formed along the landing opening frame edge. This surface can be the stainless-steel type polished surface of the landing frame edge profile, which has a slightly concave cross-section to enable convergent reflection 19b of the emitted beam 19a. The width thereof corresponds to that of the emitted beam 19a that it receives.

The converging reflected beam 19b is received by said beam receiving means 23, which is made (FIG. 2) of a vertical light-receptive strip arranged on the car opening frame edge 11 near the line of light sources 25. This light-receptive strip can be made of photoelectric cells 33 arranged regularly on its length along said edge, the outputs of which are connected in series to a door opening control circuit of the elevator (not shown).

It can then be understood that if an obstacle, particularly a finger 13, enters the space between the doors and the contiguous opening frame edges, such obstacle blocks the light beam 19a emitted by the emitting means where it is located, which produces a more or less light spot on the light-receptive strip 23 and therefore a weak output signal or no signal from the corresponding photoelectric cell or cells, so that said door control circuit triggers the halt or reverse motion of the door opening, according to how the latter is programmed. Thus the obstacle or finger can be withdrawn and the opening of the doors can then continue.

It should be noted that the device can be mounted on any type of elevator with glass car and landing doors, with one or several sections, with a lateral (one detector only) or central opening, and with clear or slightly stained glass.

In addition, the emitting and receiving means 17 and 23 can of course be mounted in the same box, and the emission and reflection of the light beam can occur in the same plane (the plane of the light sources 25).

Furthermore, the emitter light sources are not limited to visible light sources, but infrared light sources or other non visible wave lengths light are also contemplated.

In place of the polished stainless-steel reflective surface, reflective plastic or glass surface may be used.

1. Device for the detection of foreign objects, and particularly fingers, between the doors and the contiguous walls of landing and car openings in an elevator with glass car and landing doors, the device comprises:
a light beam emitter located near an opening frame edge of the car, the emitter delivers a beam that extends transversally across the car and landing glass doors from a vertical car opening frame edge to an opposite vertical landing frame edge, and
a receiver located on the vertical car opening frame edge and near the light beam emitter, the receiver to receive the emitted beam and adapted to detect any obstacle to the transverse light beam and to order a simultaneous halt and reversal, as required, of car and landing door displacement at the elevator landing level, wherein the detection device is actuated by a car and landing door opening command.

2. Detection device as per claim 1, wherein the light beam emitted from a vertical car frame opening edge is reflected on the opposite vertical landing frame opening edge by a strip-shaped vertical reflective surface arranged along the length of that vertical edge, and is received by the receiver arranged on the car side.

3. Detection device as per claim 2, wherein the reflective surface has a regular concave cross-section along its height, in order to converge the reflected beam onto the receiver.

4. Detection device as per claim 2, wherein the reflective surface is formed by the polished surface of the landing frame edge, which can be made of stainless steel, reflective plastic, or reflective glass.

5. Detection device as per claim 1, wherein the receiver is a vertical light-receptive strip arranged near the vertical car opening frame edge.

6. Detection device as per claim 5, wherein the light-receptive strip is made of photoelectric cells arranged regularly along its length, wherein the electrical signals delivered thereby are transmitted to a door control circuit of the elevator.

7. Detection device as per claim 1, wherein the emitter is made of a series of unitary light sources spaced regularly on a vertical line along the vertical car opening frame edge-, which light sources are each mounted in a box attached on the back of the front wing of the car frame profile edge and which light sources each send a light beam through a hole drilled in the the front profile wing, wherein this beam is flat and perpendicular to the wing, and the individual light beams emitted by the light sources overlap and form the curtain-shaped light beam, which diverges slightly outwards and is transversal to the car and landing glass doors.

8. Elevator with glass car and landing doors, wherein the elevator is fitted with a device to detect objects as per claim 1.
